(19) United States
(12) Patent Application Publication
(10) Pub. No.: US 2023/0198109 A1
(43) Pub. Date: Jun. 22, 2023

(54) BATTERY CELL, BATTERY, ELECTRICAL DEVICE, AND METHOD AND APPARATUS FOR MANUFACTURING BATTERY CELL

(71) Applicant: CONTEMPORARY AMPEREX TECHNOLOGY CO., LIMITED, Ningde (CN)

(72) Inventors: Haihe XIAO, Ningde (CN); Xiaowen ZHANG, Ningde (CN); Baiqing LI, Ningde (CN); Haizu Jin, Ningde (CN); Xigen ZHOU, Ningde (CN)

(73) Assignee: CONTEMPORARY AMPEREX TECHNOLOGY CO., LIMITED, Ningde (CN)

(21) Appl. No.: 18/108,660

(22) Filed: Feb. 13, 2023

Related U.S. Application Data
(63) Continuation of application No. PCT/CN2021/122037, filed on Sep. 30, 2021.

(51) Int. Cl. H01M 50/538; H01M 50/474; H01M 50/566; H01M 50/166; H01M 50/119; H01M 10/0587; H01M 50/548

(52) U.S. Cl. CPC H01M 50/538; H01M 50/474; H01M 50/566; H01M 50/166; H01M 50/119; H01M 10/0587; H01M 50/548

(57) ABSTRACT

A battery cell may include a housing, a first body structure, and a second body structure. The first body structure may be disposed in the housing. The first body structure may include a first positive electrode plate and a first negative electrode plate. A second body structure may be disposed in the housing. The second body structure may include a second positive electrode plate and a second negative electrode plate. The first body structure and the second body structure may be spaced out along a first direction. An end of the first positive electrode plate, which is oriented away from the second body structure along the first direction, may protrude beyond the first body structure and contacts a first inner surface of the housing, and the first negative electrode plate may be insulated from the first inner surface of the housing.

### CROSS-REFERENCE TO RELATED APPLICATION

The present application is a continuation of International Application No. PCT/CN2021/122037, filed Sep. 30, 2021, which is incorporated herein by reference in its entirety.

### TECHNICAL FIELD

This application relates to the technical field of batteries, and in particular, to a battery cell, a battery, an electrical device, and a method and apparatus for manufacturing a battery cell.

### BACKGROUND

Energy conservation and emission reduction are key to sustainable development of the automobile industry, and electric vehicles have become an important part of the sustainable development of the automobile industry by virtue of energy saving and environmental friendliness. Battery technology is crucial to development of electric vehicles.

During charge-and-discharge cycles of a battery in use, a battery cell in the battery generates heat, thereby impairing the lifespan of the battery.

### SUMMARY

This application provides a battery cell, a battery, an electrical device, and a method and apparatus for manufacturing a battery cell to accelerate heat dissipation of the battery cell and increase a lifespan of the battery.

According to a first aspect, this application provides a battery cell, including:

a housing;

a first body portion or structure, disposed in the housing, where the first body portion includes a first positive electrode plate and a first negative electrode plate; and

a second body portion or structure, disposed in the housing, where the second body portion includes a second positive electrode plate and a second negative electrode plate.

The first body portion and the second body portion are spaced out along a first direction. An end of the first positive electrode plate, which is oriented away from the second body portion along the first direction, protrudes beyond the first body portion and contacts a first inner surface of the housing, and the first negative electrode plate is insulated from the first inner surface of the housing; and/or, an end of the second positive electrode plate, which is oriented away from the first body portion along the first direction, protrudes beyond the second body portion and contacts a second inner surface of the housing, the second negative electrode plate is insulated from the second inner surface of the housing, and the first inner surface is disposed opposite to the second inner surface.

In this embodiment of this application, the end of the first positive electrode plate of the first body portion, which is oriented away from the second body portion along the first direction, protrudes beyond the first body portion and directly contacts the first inner surface of the housing, and the end of the second positive electrode plate of the second body portion, which is oriented away from the first body portion along the first direction, protrudes beyond the second body portion and directly contacts the second inner surface of the housing. That is, both ends of an electrode assembly may be in direct contact with the housing, thereby increasing the area of direct contact between the housing and the entire battery cell formed of a first electrode assembly and a second electrode assembly. In this way, the heat generated inside the battery cell can be more quickly dissipated through the direct contact with the housing, thereby increasing heat dissipation capabilities of the battery cell, preventing the heat from accumulating in the housing to cause overtemperature of the battery, and effectively increasing the lifespan of the battery.

In some embodiments, the first positive electrode plate includes a first current collector and a first active material layer formed on the first current collector. An end of the first current collector, which is oriented away from the second body portion along the first direction, protrudes beyond the first active material layer and contacts the first inner surface of the housing. The second positive electrode plate includes a second current collector and a second active material layer formed on the second current collector. An end of the second current collector, which is oriented away from the first body portion along the first direction, protrudes beyond the second active material layer and contacts the second inner surface of the housing.

In this embodiment, the first current collector collects the current generated by the first active material layer, so as to form a larger current to be output. The first current collector, as a carrier of current collected, is a component that is prone to generate heat. Therefore, the first current collector is set to protrude toward the housing against the first body portion to facilitate direct contact between the first current collector and the housing, thereby effectively improving heat transfer efficiency and helping to rapidly reduce the temperature of the battery cell.

The second current collector collects the current generated by the second active material layer, so as to form a larger current to be output. The second current collector, as a carrier of current collected, is a component that is prone to generate heat. Therefore, the second current collector is set to protrude toward the housing against the second body portion to facilitate direct contact between the second current collector and the housing, thereby effectively improving heat transfer efficiency and helping to rapidly reduce the temperature of the battery cell.

In some embodiments, an end of the first negative electrode plate, which is oriented away from the second body portion along the first direction, is at a first preset distance from the first inner surface of the housing. An end of the second negative electrode plate, which is oriented away from the first body portion along the first direction, is at a second preset distance from the second inner surface of the housing. In this way, the first negative electrode plate keeps insulated from the housing, and the second negative electrode plate keeps insulated from the housing, thereby preventing a short circuit caused by electrical conduction between the first positive electrode plate and the first negative electrode plate in a case that the first positive electrode plate is in contact with the housing, or by electrical conduction between the second positive electrode plate and the second negative electrode plate in a case that the second positive electrode plate is in contact with the housing. The short circuit impairs the safety of the battery cell.

In some embodiments, the battery cell further includes a first positive tab and a first negative tab that extend from the first body portion as well as a second positive tab and a second negative tab that extend from the second body portion. The first positive tab and the first negative tab are disposed at an end of the first body portion, where the end is close to the second body portion along the first direction. The second positive tab and the second negative tab are disposed at an end of the second body portion, where the end is close to the first body portion along the first direction.

In the foregoing embodiment, the first positive tab, the first negative tab, the second positive tab, and the second negative tab are all disposed in the space between the first body portion and the second body portion, thereby helping to increase the area of direct contact between the electrode assembly and the housing and enhancing the effect of heat transfer between the electrode assembly and the housing. Moreover, this can also shorten the distance between the first positive tab and the second positive tab and the distance between the first negative tab and the second negative tab, shorten the current transfer path, reduce energy consumption, reduce heat emission, and prevent overtemperature of the battery cell from impairing the lifespan and safety of the battery cell in use.

In some embodiments, the battery cell further includes a bracket. The bracket is disposed between the first body portion and the second body portion to make the first positive electrode plate keep in contact with the first inner surface of the housing, and to make the second positive electrode plate keep in contact with the second inner surface of the housing.

In the foregoing embodiment, the bracket disposed can support the first body portion and the second body portion, make the first positive electrode plate keep in contact with the first inner surface of the housing, and make the second positive electrode plate keep in contact with the second inner surface of the housing. In this way, it is prevented that, due to gravity, an external force, or other factors, the first positive electrode plate is remote from the first inner surface of the housing, and the second positive electrode plate is remote from the second inner surface of the housing. The remoteness impairs the heat transfer efficiency, reduces the heat dissipation speed, and results in overtemperature of the battery cell.

In some embodiments, the bracket includes a first support portion or structure, a second support portion or structure, and a third support portion or structure connected between the first support portion and the second support portion. The first support portion is configured to serve as a support between the first body portion and a first positive tab and a support between the first body portion and a first negative tab. The second support portion is configured to serve as a support between the second body portion and a second positive tab and a support between the second body portion and a second negative tab. The advantages of the bracket with such a structure are: when the battery cell is in a working state, no matter whether the first electrode assembly or the second electrode assembly is located above, the first electrode assembly and the second electrode assembly can be supported effectively, thereby facilitating installation and operation.

In some embodiments, the battery cell further includes a first adapter piece or adapter, a second adapter piece or adapter, a positive post, and a negative post. The first positive tab and the second positive tab are both connected to the first adapter piece. The first adapter piece is connected to the positive post. The first negative tab and the second negative tab are both connected to the second adapter piece. The second adapter piece is connected to the negative post.

In some of the above embodiments, the first positive tab and the second positive tab are both connected to the first adapter piece. The first negative tab and the second negative tab are both connected to the second adapter piece. Therefore, the first electrode assembly and the second electrode assembly share an adapter piece, thereby reducing the number of components of the battery cell and saving cost. In addition, the sharing of the adapter piece also simplifies the internal structural layout of the battery cell, saves space, and reduces the size of the battery cell.

In some embodiments, the positive post is mounted on a first side face of the housing, and the negative post is mounted on a second side face of the housing. The first side face is disposed opposite to the second side face, and both the first side face and the second side face are parallel to the first direction.

In this embodiment, the positive post and the negative post are disposed on the two sides of the housing with respect to the first direction respectively. In this way, the first positive tab and the second positive tab that are located between the first body portion and the second body portion can be conveniently connected to the positive post by extending transversely, and the first negative tab and the second negative tab that are located between the first body portion and the second body portion can be conveniently connected to the negative post by extending transversely, thereby shortening the first adapter piece and the second adapter piece. Circuit loss and heat emission can be reduced by shortening the first adapter piece and the second adapter piece.

In some embodiments, the battery cell further includes a first end cap and a second end cap. A first opening is made on the first side face of the housing, and a second opening is made on the second side face of the housing. The first end cap is configured to seal the first opening, and the second end cap is configured to seal the second opening. With the two end caps disposed, the electrode assembly may be put into the housing along the direction perpendicular to the first direction first, and then the two openings are closed by the two end caps respectively, thereby improving the convenience of assembling.

In some embodiments, the battery cell further includes a first sleeve. The positive post includes a first inner post and a first outer post. The first sleeve is mounted on the first end cap. The first outer post is disposed on an outer side of the first end cap and connected to the first sleeve. The first adapter piece is connected to a first end of the first inner post. A second end of the first inner post passes through the first sleeve and is connected to the first sleeve on an outer side of the housing. This structure improves the convenience of assembling the battery cell, helps to fix and connect the first inner post and the first sleeve outside the housing, and improves the convenience of operation.

In some embodiments, the battery cell further includes a second sleeve. The negative post includes a second inner post and a second outer post. The second sleeve is mounted on the second end cap. The second outer post is disposed on an outer side of the second end cap and connected to the second sleeve. The second adapter piece is connected to a second end of the second inner post. The second end of the second inner post passes through the second sleeve and is connected to the second sleeve on an outer side of the housing. This structure improves the convenience of assembling the battery cell, helps to fix and connect the second inner post and the second sleeve outside the housing, and improves the convenience of operation.

In some embodiments, the first adapter piece includes a first connecting portion or structure extending in a direction perpendicular to the first direction, the first connecting portion is connected to the first positive tab and the second positive tab, and an end that is of the first connecting portion and that is close to the positive post is connected to the positive post. Alternatively, the first adapter piece includes a first connecting portion extending in a direction perpendicular to the first direction and a second connecting portion or structure extending in a direction parallel to the first direction, the first connecting portion and the second connecting portion are connected to form an L shape, the first connecting portion is connected to the first positive tab and the second positive tab, and the second connecting portion is connected to the positive post. This structure helps to enhance stability of electrical connection between the first adapter piece and the positive post by increasing the contact area between the first adapter piece and the positive post.

In some embodiments, the second adapter piece includes a third connecting portion or structure extending in a direction perpendicular to the first direction, the third connecting portion is connected to the first negative tab and the second negative tab, and an end that is of the third connecting portion and that is close to the negative post is connected to the negative post. Alternatively, the second adapter piece includes a third connecting portion extending in a direction perpendicular to the first direction and a fourth connecting portion or structure extending in a direction parallel to the first direction, the third connecting portion and the fourth connecting portion are connected to form an L shape, the third connecting portion is connected to the first negative tab and the second negative tab, and the fourth connecting portion is connected to the negative post. This structure helps to enhance stability of electrical connection between the second adapter piece and the negative post by increasing the contact area between the second adapter piece and the negative post.

In some embodiments, the battery cell further includes a first insulation piece or insulator disposed in the housing. The first insulation piece is configured to electrically isolate the negative post from the housing. The first insulation piece disposed reduces the risk of a short circuit between the positive electrode and the negative electrode, and improves the safety of the battery cell in use.

In some embodiments, the first body portion further includes a first separator, the first body portion is formed by winding the first positive electrode plate, the first negative electrode plate, and the first separator together, and the first direction is parallel to a winding centerline of the first body portion; and/or, the second body portion further includes a second separator, the second body portion is formed by winding the second positive electrode plate, the second negative electrode plate, and the second separator together, and the first direction is parallel to a winding centerline of the second body portion.

In some embodiments, the housing is made of a metal material. In this way, a metal-to-metal direct contact structure is formed between the first positive electrode plate and the housing; and between the second positive electrode plate and the housing, thereby effectively improving the heat dissipation efficiency and reducing the temperature of the battery cell.

According to a second aspect, this application provides a battery, including the battery cell.

According to a third aspect, this application provides an electrical device, including the battery. The battery is configured to supply electrical energy to the electrical device.

According to a fourth aspect, this application provides a method for manufacturing a battery cell, including:

providing a housing, a first body portion, and a second body portion, where the first body portion includes a first positive electrode plate and a first negative electrode plate, and the second body portion includes a second positive electrode plate and a second negative electrode plate;

disposing both the first body portion and the second body portion in the housing; and

spacing out the first body portion and the second body portion along a first direction, where an end of the first positive electrode plate, which is oriented away from the second body portion along the first direction, contacts a first inner surface of the housing, and an end of the first negative electrode plate, which is oriented away from the second body portion along the first direction, is insulated from the first inner surface of the housing; and/or, an end of the second positive electrode plate, which is oriented away from the first body portion along the first direction, contacts a second inner surface of the housing, an end of the second negative electrode plate, which is oriented away from the first body portion along the first direction, is insulated from the second inner surface of the housing, and the first inner surface is disposed opposite to the second inner surface.

According to a fifth aspect, this application provides an apparatus for manufacturing a battery cell, including:

a providing apparatus, configured to provide a housing, a first body portion, and a second body portion, where the first body portion includes a first positive electrode plate and a first negative electrode plate, and the second body portion includes a second positive electrode plate and a second negative electrode plate; and

a placement apparatus, configured to dispose both the first body portion and the second body portion in the housing, and space out the first body portion and the second body portion along a first direction, where an end of the first positive electrode plate, which is oriented away from the second body portion along the first direction, contacts a first inner surface of the housing, and an end of the first negative electrode plate, which is oriented away from the second body portion along the first direction, is insulated from the first inner surface of the housing; and/or, an end of the second positive electrode plate, which is oriented away from the first body portion along the first direction, contacts a second inner surface of the housing, an end of the second negative electrode plate; which is oriented away from the first body portion along the first direction, is insulated from the second inner surface of the housing, and the first inner surface is disposed opposite to the second inner surface.

The battery and the electrical device according to this application each include the battery cell according to embodiments of this application. Therefore, both the battery and the electrical device possess the advantages of fast heat dissipation and low temperature, thereby helping to improve the safety performance and increase the lifespan. The method for manufacturing a battery cell and the apparatus for manufacturing a battery cell according to this application also possess the foregoing advantages, details of which are omitted here.

The foregoing description is merely an overview of the technical solutions of this application. The following describes specific embodiments of this application illustratively to enable a clearer understanding of the technical solutions of this application, enable implementation of the technical solutions based on the content of the specification, and make the foregoing and other objectives, features, and advantages of this application more evident and comprehensible.

### BRIEF DESCRIPTION OF′ DRAWINGS

To describe the technical solutions of the embodiments of this application more clearly, the following outlines the drawings used in the embodiments of this application. Evidently, the drawings outlined below are merely a part of embodiments of this application. A person of ordinary skill in the art may derive other drawings from the outlined drawings without making any creative efforts,

FIG. 1 is a schematic structural diagram of an electrical device according to some embodiments of this application;

FIG. 2 is a schematic structural diagram of a battery according to some embodiments of this application;

FIG. 3 is a three-dimensional diagram of a battery cell according to some embodiments of this application;

FIG. 4 is a front view of a battery cell according to some embodiments of this application;

FIG. 5 is a top view of a battery cell according to some embodiments of this application;

FIG. 6 is a left view of a battery cell according to some embodiments of this application;

FIG. 7 is a sectional view of sectioning along a line A-A shown in FIG. 4 according to some embodiments of this application;

FIG. 8 is a close-up view of a part P1 shown in FIG. 7 according to some embodiments of this application;

FIG. 9 is a close-up view of a part P2 shown in FIG. 7 according to some embodiments of this application;

FIG. 10 is a close-up view of a part P3 shown in FIG. 7 according to some embodiments of this application;

FIG. 11 is a sectional view of sectioning along a line B-B shown in FIG. 4 according to some embodiments of this application;

FIG. 12 is a front view of a bracket in a battery cell according to some embodiments of this application;

FIG. 13 is a top view of a bracket in a battery cell according to some embodiments of this application;

FIG. 14 is a left view of a bracket in a battery cell according to some embodiments of this application;

FIG. 15 is a sectional view of sectioning along a line C-C shown in FIG. 5 according to some embodiments of this application;

FIG. 16 is a close-up view of a part P4 shown in FIG. 15 according to some embodiments of this application;

FIG. 17 is a schematic structural diagram of connection between a negative post and a second adapter piece according to some embodiments of this application;

FIG. 18 is a sectional view of sectioning along a line C-C shown in FIG. 5 according to other embodiments of this application;

FIG. 19 is a close-up view of a part P5 shown in FIG. 18 according to some embodiments of this application; and

FIG. 20 is a schematic structural diagram of connection between a negative post and a second adapter piece according to other embodiments of this application.

The drawings are not drawn to scale.

### REFERENCE NUMERALS

1000. vehicle; 100. battery; 200. controller; 300. motor; 101. first cover body; 102. second cover body; 10a. shell; 20. battery cell; 1. housing; 1a. first end cap; 1b. second end cap; 2. first electrode assembly; 21. first body portion; 211. first positive electrode plate; 211a. first current collector; 211b, first active material layer; 212. first negative electrode plate; 212a third current collector; 212b. third active material layer; 22. first positive tab; 23. first negative tab; 3. second electrode assembly; 31. second body portion; 311. second positive electrode plate; 311a, second current collector; 311b, second active material layer; 312. second negative electrode plate; 312a. fourth current collector; 312h. fourth active material layer; 32. second positive tab; 33. second negative tab; 4. bracket; 41. first support portion; 42. second support portion; 43. third support portion; 5. first adapter piece; 51. first connecting portion; 52. second connecting portion; 6. second adapter piece; 61. third connecting portion; 62. fourth connecting portion; 7a. first sleeve; 7. positive post; 71. first inner post; 72. first outer post; 8a. second sleeve; 8. negative post; 81. second inner post; 82. second outer post; 9. first insulation piece; 10. second insulation piece.

### DETAILED DESCRIPTION OF EMBODIMENTS

Embodiments of the technical solutions of this application are described in detail below with reference to the drawings. The following embodiments are merely intended to describe the technical solutions of this application more clearly, and serve merely as examples but without hereby limiting the protection scope of this application.

Unless otherwise defined, all technical and scientific terms used herein have the same meanings as commonly understood by a. person skilled in the technical field of this application. The terms used herein are merely intended to describe specific embodiments but not intended to limit this application. The terms “include” and “contain” and any variations thereof used in the specification, claims, and brief description of drawings of this application are intended as non-exclusive inclusion.

In the description of the embodiments of this application, the technical terms “first” and “second” are merely intended to distinguish between different items but not intended to indicate or imply relative importance or implicitly specify the number of the indicated technical features, specific order, or order of precedence. In addition, the term “perpendicular” does not means exact perpendicularity, but means perpendicularity falling within an error tolerance range. “Parallel” does not mean exact parallelism, but means parallelism falling within an error tolerance range.

Reference to “embodiment” herein means that a specific feature, structure or characteristic described with reference to the embodiment may be included in at least one embodiment of this application. Reference to this term in different places in the specification does not necessarily represent the same embodiment, nor does it represent an independent or alternative embodiment in a mutually exclusive relationship with other embodiments. A person skilled in the art explicitly and implicitly understands that the embodiments described herein may be combined with other embodiments.

In the description of embodiments of this application, the term “and/or” merely indicates a relationship between related items, and represents three possible relationships. For example, “A and/or B” may represent the following three circumstances: A alone, both A and B, and B alone. In addition, the character “I” herein generally indicates an “or” relationship between the item preceding the character and the item following the character.

In the description of the embodiments of this application, unless otherwise expressly specified, the term “a plurality of” means two or more. Similarly, unless otherwise expressly defined, “a plurality of groups” means two or more groups, and “a plurality of pieces” means two or more pieces.

In the description of embodiments of this application, a direction or a positional relationship indicated by the terms such as “center”, “longitudinal”, “transverse”, “length”, “width”, “thickness”, “up”, “down”, “before”, “after”, “left”, “right”, “vertical”, “horizontal”, “top”, “bottom”, “in”, “out”, “clockwise”, “counterclockwise”, “axial”, “radial”, and “circumferential” is a direction or positional relationship based on the illustration in the drawings, and is merely intended for ease or brevity of description of embodiments of this application, but not intended to indicate or imply that the indicated device or component is necessarily located in the specified direction or constructed or operated in the specified direction. Therefore, such terms are not to be understood as a limitation on embodiments of this application.

In the description of the embodiments of this application, unless otherwise expressly specified and defined, the technical terms such as “mounting”, “concatenation”. “connection”, and “fixing” need to be understood in a broad sense, for example, understood as a fixed connection or a detachable connection or integrally connected; or understood as a mechanical connection or an electrical connection understood as a direct connection, or an indirect connection implemented through an intermediary; or understood as internal communication between two components or interaction between two components. A person of ordinary skill in the art can understand the specific meanings of the terms in the embodiments of this application according to specific situations.

Currently, as can be seen from the market trend, the application of power batteries is increasingly extensive. Power batteries are not only used in energy storage power systems such as hydro, thermal, wind, and solar power stations, but also widely used in electric means of transport such as electric bicycles, electric motorcycles, and electric vehicles, and used in many other fields such as military equipment and aerospace. The market demand for power batteries keeps expanding with the widening of the fields to which the power batteries are applicable.

The inventor of this application has noticed that some heat is generated inside a battery during charge-and-discharge cycles. When the heat accumulates a lot, an electrolytic solution evaporates and gradually dries up. Consequently, the charging efficiency decreases, electrode plates are deformed, an internal resistance increases, oxidation of mechanical parts are accelerated, and the electrode plate or separator is burned out, ending up with a reduced battery capacity and a shortened lifespan.

To overcome a series of adverse effects caused by battery heating, some countermeasures of lowering temperatures are employed in the related art. For example, a liquid cooling system is disposed inside the battery. A liquid in the liquid cooling system cools the battery and reduces the temperature. However, such a temperature lowering method involves a special-purpose liquid cooling system disposed inside the battery. An accommodation space needs to be reserved for the liquid cooling system inside the battery, thereby increasing the size of the battery. Consequently, the number of batteries that can be placed in the limited space of the electrical device decreases, and the electrical energy available from a battery system also decreases, thereby deteriorating user experience.

Through deeper research, the inventor finds that the heat transfer efficiency of two objects in direct contact with each other is much higher than that of the same objects not in direct contact. Therefore, a battery cell may be made in direct contact with the housing to improve heat dissipation capabilities of the battery cell. Compared with the cooling method that arranges a liquid cooling system inside the battery, the heat dissipation method by direct contact reduces the size of the battery greatly, helps to increase the total number of batteries accommodated in a limited space, and in turn, increases the total capacity of the battery system and improves the power performance.

To increase the area of direct contact between the battery cell and the housing, the inventor has carried out research on the structure of an existing battery cell, and finds that, in a structure of a currently available battery cell, a positive post and a negative post are usually arranged on the same top cover, and extension directions of the positive post and the negative post are usually the same as an protruding direction of a tab inside the battery cell. As limited by this structure, the connection between a positive electrode and a negative electrode of the battery cell has to be implemented at the same side of the battery cell. For example, the positive electrode and the negative electrode of the battery cell are connected at the top of the battery cell. Consequently, only the bottom of the entire battery cell can contact the housing outside the battery cell, resulting in poor heat dissipation of the battery cell.

Based on the above research, the inventor holds that the area of direct contact between the battery cell and the housing can be increased by changing the structure of the battery cell, so as to help the battery cell to dissipate heat quickly, effectively reduce the heat accumulated inside the battery cell, avoid accelerated aging of the battery cell, prevent accumulated heat from causing thermal runaway of the battery cell in extreme cases, and effectively increase the lifespan of the battery.

For this purpose, the inventor discloses a battery cell with an improved structure. In an embodiment of a battery cell according to this application, both the top and the bottom of the battery cell can be in direct contact with the housing, thereby effectively improving heat transfer efficiency, improving heat dissipation capabilities of the battery cell, preventing heat from accumulating inside the battery cell, and avoiding an adverse effect so caused to the battery life.

The battery cell disclosed in this embodiment of this application is applicable to, but without being limited to, electrical devices such as a vehicle, watercraft, or aircraft. A power supply system of the electrical devices may contain the battery cell, the battery and the like disclosed in this application to help accelerate heat dissipation of the battery cell, prevent overtemperature of the battery cell, and effectively increase the lifespan of the battery.

An embodiment of this application provides an electrical device that uses a battery as a power supply. The battery is configured to supply electrical energy to the electrical device. The electrical device may be, but without being limited to, a mobile phone, a portable device, a notebook computer, an electric power cart, an electric vehicle, a ship, a spacecraft, an electric toy, an electric tool, or the like. For example, the spacecraft includes an airplane, a rocket, a space shuttle, a spaceship, and the like. The electric toy includes a fixed or mobile electric toy, such as a game console, an electric car toy, an electric ship toy, an electric airplane toy, and the like. The electric tool includes an electric tool for metal cutting, an electric grinding tool, an electric assembly tool, an electric tool for railways, such as an electric drill, an electric grinder, an electric wrench, an electric screwdriver, an electric hammer, an electric impact drill, a concrete vibrator, or an electric planer.

For ease of description in the following embodiments, a vehicle 1000 is used as an example of the electrical device disclosed in some embodiments of this application.

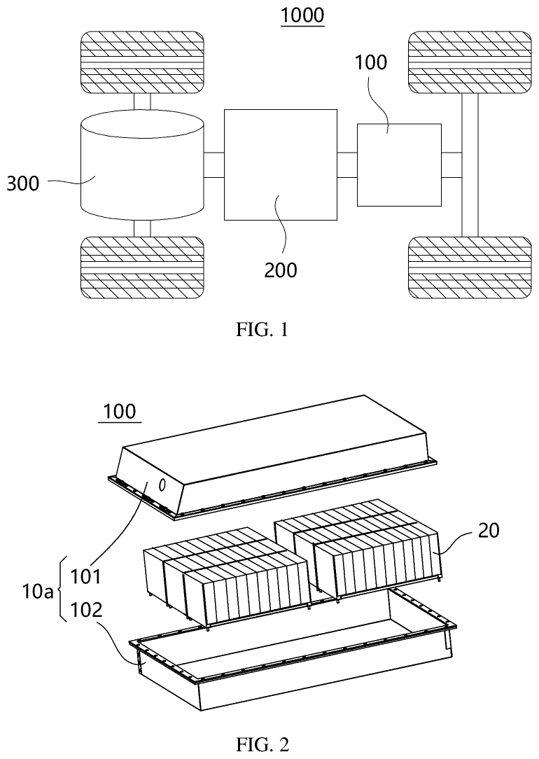

Referring to FIG. 1, FIG. 1 is a schematic structural diagram of a vehicle 1000 according to some embodiments of this application. The vehicle 1000 may be an oil-fueled vehicle, a natural gas vehicle, or a new energy vehicle. The new energy vehicle may be a battery electric vehicle, a hybrid electric vehicle, a range-extended electric vehicle, or the like. A battery 100 is disposed inside the vehicle 1000. The battery 100 may be disposed at the bottom, front, or rear of the vehicle 1000. The battery 100 may be configured to supply power to the vehicle 1000. For example, the battery 100 may serve as an operating power supply of the vehicle 1000. The vehicle 1000 may further include a controller 200 and a motor 300. The battery 100 is configured to supply electrical energy to the motor 300 and other components in the vehicle. The controller 200 is configured to control the motor 300 to work, for example, to meet electrical energy requirements in starting, navigating, or running the vehicle 1000.

In some embodiments of this application, the battery 100 serves not only as an operating power supply of the vehicle 1000, but may also serve as a drive power supply of the vehicle 1000 to provide driving power for the vehicle 1000 in place of or partly in place of oil or natural gas.

Referring to FIG. 2, FIG. 2 is an exploded view of a battery 100 according to some embodiments of this application. The battery 100 includes a shell 10a and a battery cell 20. The battery cell 20 is accommodated in the shell 10a. The shell 10a is configured to provide an accommodation space for the battery cell 20. The structure of the shell 10a may be diversified. In some embodiments, the shell 10a may include a first cover body 101 and a second cover body 102. The first cover body 101 and the second cover body 102 fit each other. The first cover body 101 and the second cover body 102 together define an accommodation space configured to accommodate the battery cell 20. The second cover body 102 may be a hollowed-out structure that is opened at one end. The first cover body 101 may be a plate-like structure. The first cover body 101 fits on an opening of the second cover body 102 so that the first cover body 101 and the second cover body 102 together define the accommodation space. Alternatively, both the first cover body 101 and the second cover body 102 may be hollowed-out structures, each being opened at one side. The opening of the first cover body 101 fits the opening of the second cover body 102. Definitely, the shell 10a formed by the first cover body 101 and the second cover body 102 may be in various shapes, such as a cylinder or a cuboid.

The battery 100 may contain a plurality of battery cells 20. The plurality of battery cells 20 may be connected in series, parallel, or series-and-parallel pattern. The series-and-parallel pattern means a combination of series connection and parallel connection of the plurality of battery cells 20. The plurality of battery cells 20 may be directly connected in series, parallel, or series-and-parallel pattern, and then the whole of the plurality of battery cells 20 may be accommodated in the shell 10a. Alternatively, the plurality of battery cells 20 may be connected in series, parallel, or series-and-parallel pattern to form a battery 100 that is in the form of a battery module. A plurality of battery modules are then connected in series, parallel, or series-and-parallel pattern to form a whole for being accommodated in the shell 10a. The battery 100 may further include other structures. For example, the battery 100 may further include a busbar component. The busbar component is configured to implement electrical connection between the plurality of battery cells 20.

The battery cell 20 is a minimum unit for making up a battery. The battery cells 20 include a lithium-ion secondary battery, a lithium-ion primary battery. a lithium-sulfur battery, a sodium-lithium-ion battery, a sodium-ion battery, a magnesium-ion battery, or the like, without being limited in embodiments of this application. The battery cell may be in a cylindrical shape, a flat shape, a cuboidal shape, or other shapes, without being limited in embodiments of this application. Depending on the form of packaging, the battery cell is typically classed into three types: cylindrical cell, prismatic cell, and pouch-type cell, without being limited in embodiments of this application.

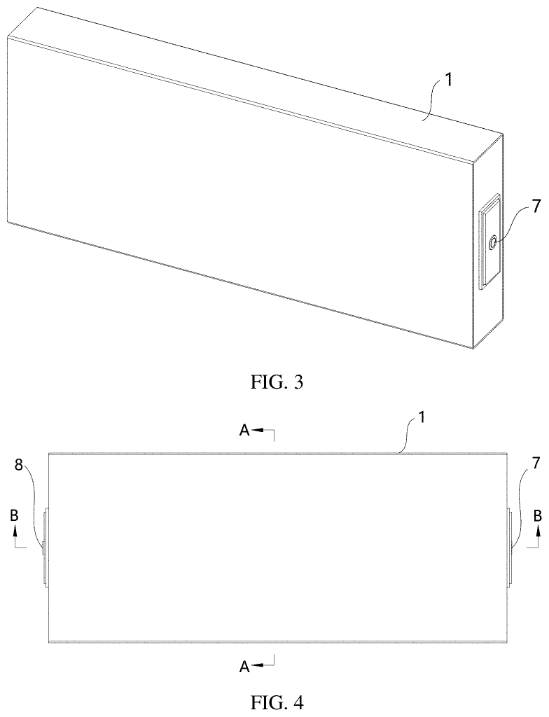

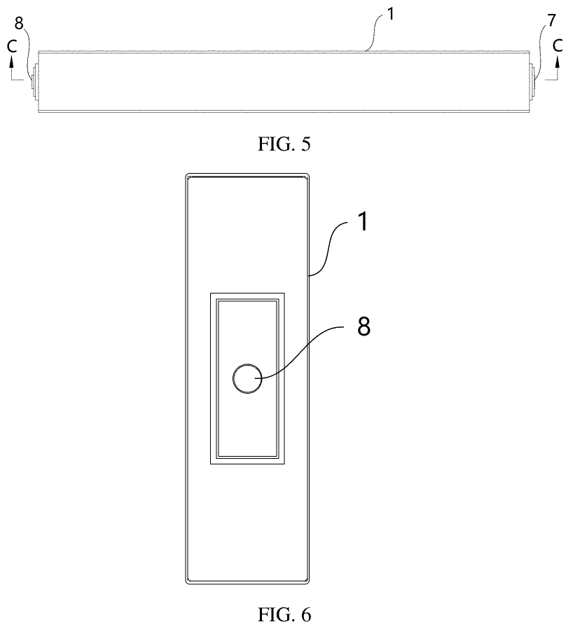

Refer to FIG. 3 to FIG. 6, which are a three-dimensional view, front view, top view; and left view, respectively, of a battery cell 20 according to some embodiments of this application. In some embodiments of this application, the battery cell 20 includes a housing 1 and an electrode assembly. The electrode assembly is disposed inside the housing 1.

The housing 1 is a component configured to provide an accommodation space for accommodating the electrode assembly, an electrolytic solution, and other components. The housing 1 includes an accommodation body with an opening, and an end cap configured to close the opening. The accommodation body and the end cap may be stand-alone components. An opening is made on the accommodation body. At the opening, the end cap fits the opening to form an internal environment of the battery cell 20. Without constituting any limitation, the end cap and the accommodation body may be integrated instead. Specifically, the end cap and the accommodation body may form a common connection interface first before other components are put into the housing. When the accommodation body needs to be sealed, the end cap is made to fit the accommodation body so that the accommodation body and the end cap are sealed in one piece.

The accommodation body is a component configured to fit with the end cap to form an internal environment of the battery cell 20. The end cap is a component that fits the opening of the accommodation body to isolate the internal environment of the battery cell 20 from the external environment. Without constituting any limitation, the shape of the end cap may be adapted to the shape of the accommodation body to fit with the accommodation body. Optionally, the end cap may be made of a material that is appropriately hard and strong, so that the end cap is not prone to deform under an extrusion force or expansion force. In this way, the battery cell 20 achieves higher structural strength and higher safety performance.

In some embodiments, the end cap may be equipped with a pressure relief mechanism configured to release an internal pressure when the internal pressure or temperature of the battery cell 20 reaches a threshold.

The housing 1 may be in various shapes and sizes, such as a cuboid, cylinder, or hexagonal prism. Specifically, the shape of the housing 1 may be determined. depending on the specific shape and size of the electrode assembly. The material of the housing 1 may be a metal material such as copper, iron, aluminum, stainless steel, or aluminum alloy, or may be a non-metallic material such as plastic.

The electrode assembly is a component that reacts electrochemically in the battery cell 20. In some embodiments of this application, the electrode assembly includes a first electrode assembly 2 and a second electrode assembly 3. The first electrode assembly 2 includes a first body portion 21. The first body portion 21 is disposed in the housing 1. The first body portion 21 includes a first positive electrode plate 211 and a first negative electrode plate 212. The second electrode assembly includes a second body portion 31. The second body portion 31 is disposed in the housing 1. The second body portion 31 includes a second positive electrode plate 311 and a second negative electrode plate 312.

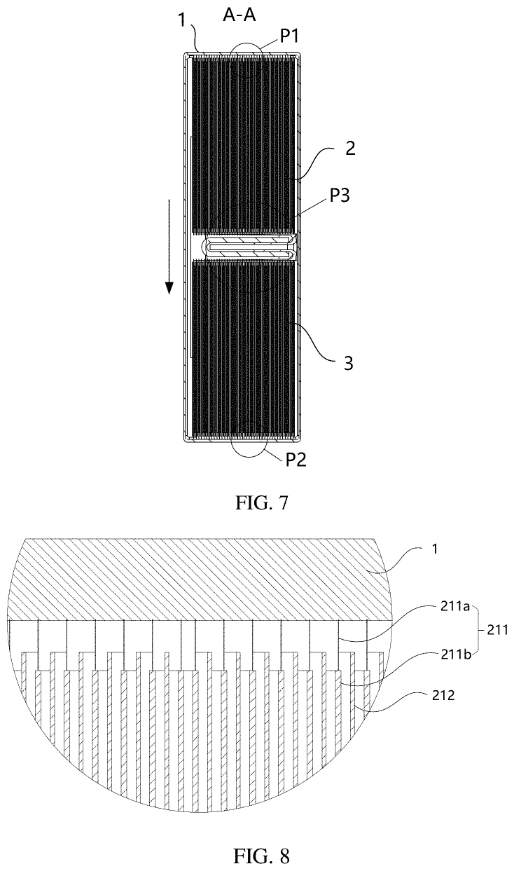

Referring to FIG. 7 to FIG. 9, the first body portion 21 and the second body portion 31 are spaced out along a first direction. An end of the first positive electrode plate 211, which is oriented away from the second body portion 31 along the first direction, protrudes beyond the first body portion 21 and contacts a. first inner surface of the housing 1, and the first negative electrode plate 212 is insulated from the first inner surface of the housing 1; and/or, an end of the second positive electrode plate 311, which is oriented away from the first body portion 21 along the first direction, protrudes beyond the second body portion 31 and contacts a second inner surface of the housing 1, the second negative electrode plate 312 is insulated from the second inner surface of the housing 1, and the first inner surface is disposed opposite to the second inner surface.

In the battery cell according to some embodiments of this application, the electrode assembly includes a first body portion 21 and a second body portion 31 that are spaced out along the first direction. The end of the first positive electrode plate 211 of the first body portion 21, which is oriented away from the second body portion 31 along the first direction, protrudes beyond the first body portion 21 and directly contacts the first inner surface of the housing 1. and the end of the second positive electrode plate 311 of the second body portion 31, which is oriented away from the first body portion 21 along the first direction, protrudes beyond the second body portion 31 and directly contacts the second inner surface of the housing 1. That is, both ends of an electrode assembly may be in direct contact with the housing 1, thereby increasing the area of direct contact between the housing 1 and the entire battery cell formed of the first electrode assembly 2 and the second electrode assembly 3. In this way, the heat generated inside the battery cell can be more quickly dissipated through the direct contact with the housing 1, thereby increasing heat dissipation capabilities of the battery cell, preventing the heat from accumulating in the housing 1 to cause overtemperature of the battery, and effectively increasing the lifespan of the battery.

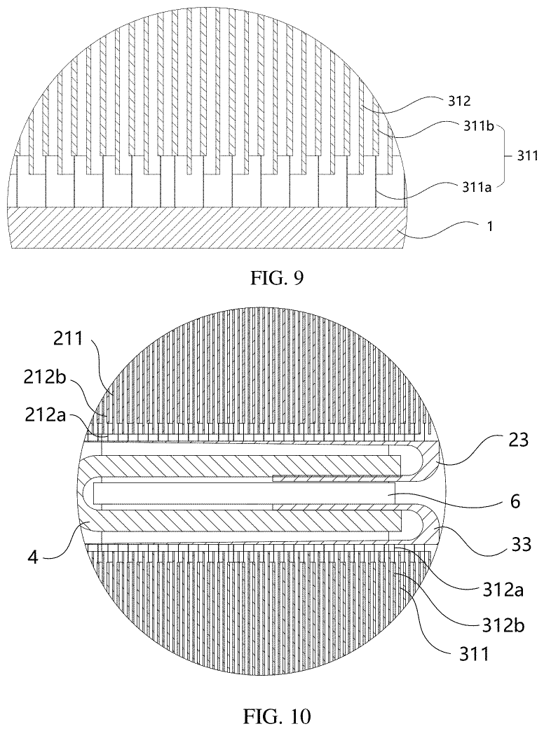

In the embodiment shown in FIG. 7. an up-down direction indicated by the arrow in FIG. 7 is the first direction, and the first electrode assembly 2 is disposed above the second electrode assembly 3. As shown in FIG. 8, the first electrode assembly 2 includes a first body portion 21. The length of the first positive electrode plate 211 in the first body portion 21 is greater than the length of the first negative electrode plate 212. An upper end of the first positive electrode plate 211 protrudes from the top of the first body portion 21, so that the upper end of the first positive electrode plate 211 is in direct contact with an upper inner surface of the housing 1. As shown in FIG. 9, the length of the second positive electrode plate 311 in the second body portion 31 is greater than the length of the second negative electrode plate 312. A lower end of the second positive electrode plate 311 protrudes from the top of the second body portion 31, so that the lower end of the second positive electrode plate 311 is in direct contact with a lower inner surface of the housing 1. Therefore, the heat transfer efficiency is relatively high between the first positive electrode plate 211 and the housing 1, and between the second positive electrode plate 311 and the housing 1. The heat generated inside the electrode assembly can be dissipated in time to lower the temperature of the battery cell and improve the lifespan and safety performance of the battery cell.

In some embodiments, the first positive electrode plate 211 includes a first current collector 211a and a first active material layer 211b formed on the first current collector 211a. An end of the first current collector 211a; which is oriented away from the second body portion 31 along the first direction, protrudes beyond the first active material layer 211b and contacts the first inner surface of the housing 1. The second positive electrode plate 311 includes a second current collector 311a and a second active material layer 311b formed on the second current collector 311a. An end of the second current collector 311a, which is oriented away from the first body portion 21 along the first direction, protrudes beyond the second active material layer 311b and contacts the second inner surface of the housing 1.

The first current collector 211a collects the current generated by the first active material layer 211b, so as to form a larger current to be output. The first current collector 211a, as a carrier of current collected, is a component that is prone to generate heat. Therefore, the first current collector 211a is set to protrude toward the housing 1 against the first body portion 21 to facilitate direct contact between the first current collector 211a and the housing 1, thereby effectively improving heat transfer efficiency and helping to rapidly reduce the temperature of the battery cell 20. In addition, in order to achieve electrical conductivity, the first current collector 211a is usually a metal foil such as an aluminum foil. The housing 1 made of a metal material can implement metal-to-metal direct contact to further improve the heat transfer efficiency.

The second current collector 311a collects the current generated by the second active material layer 311b, so as to form a larger current to be output. The second current collector 311a, as a carrier of current collected, is a component that is prone to generate heat. Therefore, the second current collector 311a is set to protrude toward the housing 1 against the second body portion 31 to facilitate direct contact between the second current collector 311a and the housing 1, thereby effectively improving heat transfer efficiency and helping to rapidly reduce the temperature of the battery cell 20. In addition, in order to achieve electrical conductivity, the second current collector 311a is usually a metal foil such as an aluminum foil. The housing 1 made of a metal material can implement metal-to-metal direct contact to further improve the heat transfer efficiency.

As shown in FIG. 8, the top of the first current collector 211a, slightly extends beyond the top of the first active material layer 211b. The top of the first current collector 211a includes a part uncoated with the first active material layer 211b. The end of the uncoated part is in direct contact with the inner surface of the housing 1. In this way, the heat generated by the first current collector 211a during current transfer is dissipated out of the housing 1 in time by means of the heat transfer effect of the housing 1, thereby avoiding overtemperature of the battery cell 20, and avoiding an adverse effect thereby caused to the lifespan and safety of the battery cell 20. The first negative electrode plate 212 includes a third current collector 212a and a third active material layer 212b formed on the third current collector 212a. The top of the third current collector 212a may be flush with the third active material layer 212b, or the top of the third current collector 212a slightly extends beyond the third active material layer 212h, but both the third current collector 212a and the third active material layer 212b keep insulated from the housing 1.

As shown in FIG. 9, the top of the second current collector 311a, slightly extends beyond the top of the second active material layer 311b. The top of the second current collector 311a includes a part uncoated with the second active material layer 311b. The end of the uncoated part is in direct contact with the inner surface of the housing 1, In this way, the heat generated by the second current collector 311a during current transfer is dissipated out of the housing 1 in time by means of the heat transfer effect of the housing 1, thereby avoiding overtemperature of the battery cell 20, and avoiding an adverse effect thereby caused to the lifespan and safety of the battery cell 20. The second negative electrode plate 312 includes a fourth current collector 312a and a fourth active material layer 312b formed on the fourth current collector 312a. The top of the fourth current collector 312a may be flush with the fourth active material layer 312b, or the top of the fourth current collector 312a slightly extends beyond the fourth active material layer 312b, but both the fourth current collector 312a and the fourth active material layer 312b keep insulated from the housing 1.

In some embodiments, an end of the first negative electrode plate 212, which is oriented away from the second body portion 31 along the first direction, is at a first preset distance from the first inner surface of the housing 1. An end of the second negative electrode plate 312, which is oriented away from the first body portion 21 along the first direction, is at a second preset distance from the second inner surface of the housing 1. In this way, the first negative electrode plate 212 keeps insulated from the housing 1, and the second negative electrode plate 312 keeps insulated from the housing 1, thereby preventing a short circuit caused by electrical conduction between the first positive electrode plate 211 and the first negative electrode plate 212 in a case that the first positive electrode plate 211 is in contact with the housing 1, or by electrical conduction between the second positive electrode plate 311 and the second negative electrode plate 312 in a case that the second positive electrode plate 311 is in contact with the housing 1. The short circuit impairs the safety of the battery cell 20, and may result in functional failure of the battery.

In other embodiments, in order to keep the first negative electrode plate 212 insulated from the housing 1 and keep the second negative electrode plate 312 insulated from and the housing 1, other insulation methods may be employed. For example, an insulation piece is disposed between the first negative electrode plate 212 and the housing 1 to electrically isolate the first negative electrode plate 212 from the housing 1; or, an insulation piece is disposed between the second negative electrode plate 312 and the housing 1 to electrically isolate the second negative electrode plate 312 from the housing 1.

In some embodiments, the first electrode assembly 2 further includes a first positive tab 22 and a first negative tab 23 that extend from the first body portion 21, and the second electrode assembly 3 further includes a second positive tab 32 and a second negative tab 33 that extend from the second body portion 31. The first positive tab 22 is connected to the first positive electrode plate 211. The first negative tab 23 is connected to the first negative electrode plate 212. The second positive tab 32 is connected to the second positive electrode plate 311. The second negative tab 33 is connected to the second negative electrode plate 312. The first positive tab 22 and the first negative tab 23 are disposed at an end of the first body portion 21, where the end is close to the second body portion 31 along the first direction. The second positive tab 32 and the second negative tab 33 are disposed at an end of the second body portion 31, where the end is close to the first body portion 21 along the first direction.

In some of the above embodiments, the first positive tab 22. the first negative tab 23, the second positive tab 32, and the second negative tab 33 are all located between the first body portion 21 and the second body portion 31, thereby achieving the following two effects. As a first effect, both the first positive tab 22 and the first negative tab 23 are disposed at an end of the first body portion 21, where the end is oriented away from the housing 1 along the first direction. This prevents the existence of the first positive tab 22 and the first negative tab 23 from affecting the direct contact between the end of the first positive electrode plate 211 and the first inner surface of the housing 1, where the end is oriented away from the second body portion 31 along the first direction. As a second effect, both the second positive tab 32 and the second negative tab 33 are disposed at an end of the second body portion 31, where the end is oriented away from the housing 1 along the first direction. This prevents the existence of the second positive tab 32 and the second negative tab 33 from affecting the direct contact between the end of the second positive electrode plate 311 and the second inner surface of the housing 1, where the end is oriented away from the first body portion 21 along the first direction.

The first positive tab 22, the first negative tab 23, the second positive tab 32, and the second negative tab 33 are all disposed in the space between the first body portion 21 and the second body portion 31, thereby helping to increase the area of direct contact between the electrode assembly and the housing 1 and enhancing the effect of heat transfer between the electrode assembly and the housing 1. Moreover, this can also shorten the distance between the first positive tab 22 and the second positive tab 32 and the distance between the first negative tab 23 and the second negative tab 33, shorten the current transfer path, reduce energy consumption, reduce heat emission, and prevent overtemperature of the battery cell 20 from impairing the lifespan and safety of the battery cell in use.

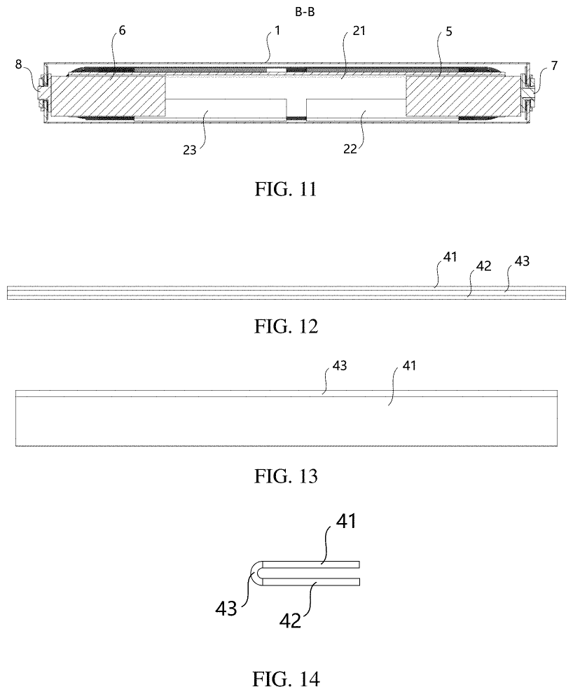

As shown in FIG. 10 and FIG. 11, the first positive tab 22 and the first negative tab 23 extend downward out of the bottom of the first body portion 21 separately. The second positive tab 32 and the second negative tab 33 extend upward out of the top of the second body portion 31 separately. The first positive tab 22, the first negative tab 23, the second positive tab 32, and the second negative tab 33 are all located in a. clearance between the first body portion 21 and the second body portion 31. In this way, the direct contact between the first positive electrode plate 211 and the housing 1 can be implemented at the top of the first body portion 21, and the direct contact between the second positive electrode plate 311 and the housing 1 can be implemented at the bottom of the second body portion 31, thereby enhancing the heat transfer effect. Moreover, the distance between the first positive tab 22 and the second positive tab 32 as well as the distance between the first negative tab 23 and the second negative tab 33 are relatively short, thereby helping to reduce heat emission and fundamentally lowering the temperature of the battery cell 20.

In some embodiments, at an end close to the second body portion 31 along the first direction, the first positive electrode plate 211 in the first body portion 21 protrudes beyond the first body portion 21 to form the first positive tab 22. At an end close to the second body portion 31 along the first direction, the first negative electrode plate 212 in the first body portion 21 protrudes beyond the first body portion 21 to form the first negative tab 23. At an end close to the first body portion 21 along the first direction, the second positive electrode plate 311 in the second body portion 31 protrudes beyond the second body portion 31 to form the second positive tab 32. At an end close to the first body portion 21 along the first direction, the second negative electrode plate 312 in the second body portion 31 protrudes beyond the second body portion 31 to form the second negative tab 33.

As shown in FIG. 10 and FIG. 11, the first positive tab 22 extends from the first body portion 21 toward the second body portion 31 first, and then extends transversely along a direction perpendicular to the first direction, so as to form a U-shaped structure on which an opening is made. The second positive tab 32 extends from the second body portion 31 toward the first body portion 21 first, and then extends transversely along a direction perpendicular to the first direction, so as to form a U-shaped structure on which an opening is made. The first negative tab 23 and the second negative tab 33 may be formed in a way similar to the way of forming the first positive tab 22 and the second positive tab 32, details of which are omitted here.

In some embodiments, the battery cell 20 further includes a bracket 4. The bracket 4 is disposed between the first body portion 21 and the second body portion 31 to make the first positive electrode plate 211 keep in contact with the first inner surface of the housing 1, and to make the second positive electrode plate 311 keep in contact with the second inner surface of the housing 1.

The bracket 4 disposed can support the first body portion 21 and the second body portion 31, make the first positive electrode plate 211 keep in contact with the first inner surface of the housing 1, and make the second positive electrode plate 311 keep in contact with the second inner surface of the housing 1. In this way, it is prevented that, due to gravity, an external force, or other factors, the first positive electrode plate 211 is remote from the first inner surface of the housing 1, and the second positive electrode plate 311 is remote from the second inner surface of the housing 1. The remoteness impairs the heat transfer efficiency, reduces the heat dissipation speed, and results in overtemperature of the battery cell.

For example, in an application scenario where the first body portion 21 and the second body portion 31 are arranged vertically, the bracket 4 may support the first body portion 21 located above, so as to prevent the second body portion 31 from being squeezed by the gravity of the first body portion 21 and prevent the second body portion 31 from being crushed. Moreover, by supporting the first body portion 21, the bracket 4 further prevents the first positive electrode plate 211 in the first body portion 21 located above from failing to keep in contact with the first inner surface of the housing 1 due to remoteness from the housing 1. The failure to keep in contact impairs the heat transfer effect, reduces the heat dissipation speed of the first electrode assembly 2, results in overtemperature of the battery cell 20, and impairs the lifespan and safety of the battery cell.

In some embodiments, the first body portion 21 includes a first separator configured to keep the first positive electrode plate 211 insulated from the first negative electrode plate 212. The second body portion 31 includes a second separator configured to keep the second positive electrode plate 311 insulated from the second negative electrode plate 312. The bracket 4 serves as a support between the first separator and the second separator. The advantage of such an arrangement is that the bracket 4 is prevented from crushing the first positive electrode plate 211, the first negative electrode plate 212, the second positive electrode plate 311, and the second negative electrode plate 312, and the arrangement helps to protect the first positive electrode plate 211, the first negative electrode plate 212, the second positive electrode plate 311, and the second negative electrode plate 312 and increase the lifespan of the electrode plates.

To enable the bracket 4 to serve as a support between the first separator and the second separator, the first separator protrudes beyond the first body portion 21 at an end close to the second body portion 31 along the first direction. In this way, at the end close to the second body portion 31 along the first direction, the first separator can extend beyond the first positive electrode plate 211 and the first negative electrode plate 212. In this way, the first separator can contact the bracket 4, and the first separator keeps being supported by the bracket 4, thereby protecting the first positive electrode plate 211 and the first negative electrode plate 212 from being squeezed. The second separator protrudes beyond the second body portion 31 at an end close to the first body portion 21 along the first direction. In this way, at the end close to the first body portion 21 along the first direction, the second separator can extend beyond the second positive electrode plate 311 and the second negative electrode plate 312. In this way, the second separator can contact the bracket 4, and the second separator keeps being supported by the bracket 4. thereby protecting the second positive electrode plate 311 and the second negative electrode plate 312 from being squeezed.

It is hereby noted that, in order to form the first positive tab 22, at the end close to the second body portion 31 along the first direction, the first positive electrode plate 211 needs to protrude beyond the first body portion 21, that is, at the end close to the second body portion 31 along the first direction, the first positive electrode plate 211 needs to extend beyond the first negative electrode plate 212 and the first separator. In order to form the first negative tab 23, at the end close to the second body portion 31 along the first direction, the first negative electrode plate 212 needs to protrude beyond the first body portion 21, that is, at the end close to the second body portion 31 along the first direction, the first negative electrode plate 212 needs to extend beyond the first positive electrode plate 211 and the first separator. In order to enable the bracket 4 to support the first separator, at the end close to the second body portion 31 along the first direction, the first separator needs to protrude beyond the first body portion 21, that is, at the end close to the second body portion 31 along the first direction, the first separator needs to extend beyond the first positive electrode plate 211 and the first negative electrode plate 212. Such three arrangements tend to be misunderstood as contradicting each other, but they are not contradictory because the first body portion 21 possesses a preset area at an end face close to the second body portion 31. No matter whether the purpose is to form the first positive tab 22 or the first negative tab 23 or enable the bracket 4 to support the first separator, the corresponding arrangement can be implemented in a preset region, and different regions in the entire end face that is of the first body portion 21 and that is close to the second body portion 31 are not necessarily made into the same structure. Therefore, the corresponding purpose can be fulfilled by arrangement in different regions.

Similarly, it is hereby noted that, in order to form the second positive tab 32, at the end close to the first body portion 21 along the first direction, the second positive electrode plate 311 needs to protrude beyond the second body portion 31, that is, at the end close to the first body portion 21 along the first direction, the second positive electrode plate 311 needs to extend beyond the second negative electrode plate 312 and the first separator. In order to form the second negative tab 33, at the end close to the first body portion 21 along the first direction, the second negative electrode plate 312 needs to protrude beyond the second body portion 31, that is, at the end close to the first body portion 21 along the first direction, the second negative electrode plate 312 needs to extend beyond the second positive electrode plate 311 and the first separator. In order to enable the bracket 4 to support the second separator, at the end close to the first body portion 21 along the first direction, the second separator needs to protrude beyond the second body portion 31, that is, at the end close to the first body portion 21 along the first direction, the second separator needs to extend beyond the second positive electrode plate 311 and the second negative electrode plate 312. Such three arrangements tend to be misunderstood as contradicting each other, but they are not contradictory because the second body portion 31 possesses a preset area at an end face close to the first body portion 21. No matter whether the purpose is to form the second positive tab 32 or the second negative tab 33 or enable the bracket 4 to support the second separator, the corresponding arrangement can be implemented in a preset region, and different regions in the entire end face that is of the second body portion 31 and that is close to the first body portion 21 are not necessarily made into the same structure. Therefore, the corresponding purpose can be fulfilled by arrangement in different regions.

In some embodiments, the bracket 4 includes a first support portion 41, a second support portion 42, and a third support portion 43 connected between the first support portion 41 and the second support portion 42. The first support portion 41 is configured to serve as a support between the first body portion 21 and a first positive tab 22 and a support between the first body portion 21 and a first negative tab 23. The second support portion 42 is configured to serve as a support between the second body portion 31 and a second positive tab 32 and a. support between the second body portion 31 and a second negative tab 33. The advantages of the bracket 4 with such a structure are: when the battery cell 20 is in a working state, no matter whether the first electrode assembly 2 or the second electrode assembly 3 is located above, the first electrode assembly 2 and the second electrode assembly 3 can be supported effectively, thereby facilitating installation and operation.

As shown in FIG. 12 to FIG. 14, a side view of the bracket 4 is U-shaped. Such a structure can support the first electrode assembly 2 and the second electrode assembly 3 through the first support portion 41 and the second support portion 42 respectively. The first support portion 41 may be inserted into an opening formed by bending the first positive tab 22 and the first negative tab 23 separately. The second support portion 42 may be inserted into an opening formed by bending the second positive tab 32 and the second negative tab 33 separately.

In some embodiments, the battery cell 20 further includes a first adapter piece 5. a second adapter piece 6, a positive post 7, and a negative post 8. The first positive tab 22 and the second positive tab 32 are both connected to the first adapter piece 5. The first adapter piece 5 is connected to the positive post 7, The first negative tab 23 and the second negative tab 33 are both connected to the second adapter piece 6. The second adapter piece 6 is connected to the negative post 8.

In some of the above embodiments, the first positive tab 22 and the second positive tab 32 are both connected to the first adapter piece 5. The first negative tab 23 and the second negative tab 33 are both connected to the second adapter piece 6. Therefore, the first electrode assembly 2 and the second electrode assembly 3 share an adapter piece, thereby reducing the number of components of the battery cell 20 and saving cost. In addition, the sharing of the adapter piece also simplifies the internal structural layout of the battery cell 20, saves space, and reduces the size of the battery cell 20.

As shown in FIG. 10 and FIG. 11, the first positive tab 22 may be arranged opposite to the second positive tab 32. The first negative tab 23 may be arranged opposite to the second negative tab 33, so as to facilitate arrangement of the first adapter piece 5 connected to the first positive tab 22 and the second positive tab 32 as well as the second adapter piece 6 connected to the first negative tab 23 and the second negative tab 33.

In some embodiments, the positive post 7 is mounted on a first side face of the housing 1, and the negative post 8 is mounted on a second side face of the housing 1. The first side face is disposed opposite to the second side face, and both the first side face and the second side face are parallel to the first direction.

The positive post 7 and the negative post 8 are disposed on the two sides of the housing 1 with respect to the first direction respectively. In this way, the first positive tab 22 and the second positive tab 32 that are located between the first body portion 21 and the second body portion 31 can be conveniently connected to the positive post 7 by extending transversely, and the first negative tab 23 and the second negative tab 33 that are located between the first body portion 21 and the second body portion 31 can be conveniently connected to the negative post 8 by extending transversely, thereby shortening the first adapter piece 5 and the second adapter piece. Circuit loss and heat emission can be reduced by shortening the first adapter piece 5 and the second adapter piece 6.

In some embodiments, the battery cell includes a first end cap 1a and a second end cap 1b. A first opening is made on the first side face of the housing 1, and a second opening is made on the second side face of the housing 2. The first end cap 1a is configured to seal the first opening, and the second end cap 1b is configured to seal the second opening. The positive post 7 is mounted on the first end cap 1a, and the negative post 8 is mounted on the second end cap 1b.

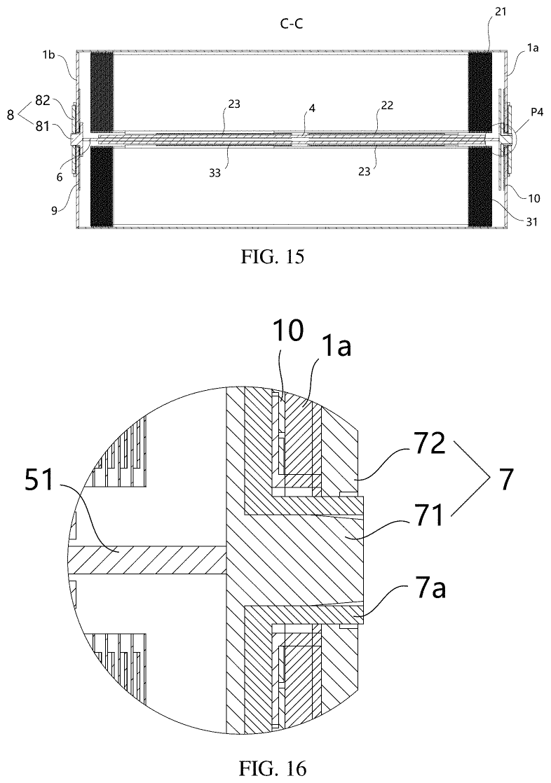

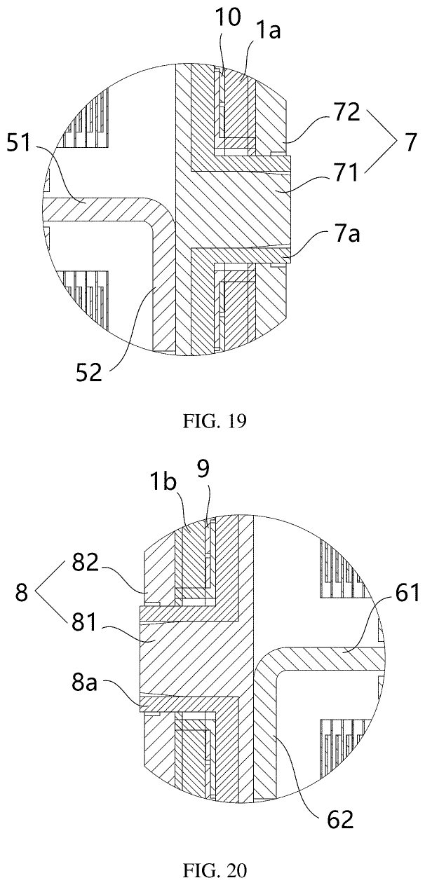

As shown in FIG. 15, FIG. 16, FIG. 18, and FIG. 19, the positive post 7 includes a first inner post 71 and a first outer post 72. The first sleeve 7a is mounted on the first end cap 1a. The first outer post 72 is disposed on an outer side of the first end cap 1a and connected to the first sleeve 7a. The first adapter piece 5 is connected to a first end of the first inner post 71. A second end of the first inner post 71 passes through the first sleeve 7a and is connected to the first sleeve 7a on an outer side of the housing 1. Compared with the inner side, the outer side of the housing 1 provides a larger operation space. Therefore, the first inner post 71 and the first sleeve 7a are fixed and connected on the outer side of the housing 1, thereby making the operation more convenient and helping to improve the assembling efficiency.

The positive post 7 containing the first inner post 71 and the first outer post 72 is disposed, the first sleeve 7a is disposed, and the first sleeve 7a is mounted on the first end cap 1a. During assembling of the battery cell, the first adapter piece 5 may be connected to the first end of the first inner post 71 first, and then the electrode assembly is put into the housing 1. Subsequently, during sealing of the first end cap 1a, the second end of the first inner post 71 is passed out of the housing 1 through the first sleeve 7a. After the first end cap 1a is fixed, the first inner post 71 is connected to the first sleeve 7a on the outer side of the housing 1. In this way, the first inner post 71 and the first outer post 72 are connected together through the first sleeve 7a to form the positive post 7.

The first sleeve 7a includes a first sleeve portion and a first limiting portion. A first through-hole is made on the first end cap 1a. The first sleeve portion is inserted into the first through-hole. The first limiting portion is connected to the first sleeve portion. The first limiting portion is located on the inner side of the first end cap 1a. The first limiting portion is larger than the first through-hole in size, so as to limit the position of the first sleeve portion and prevent the first sleeve portion from detaching from the first through-hole.

A second through-hole that runs through the first sleeve is made at the center of the first sleeve 7a. The first inner post 71 includes a first post portion and a second limiting portion. The first post portion is inserted into the second through-hole. The second limiting position is connected to the first post portion. The second limiting portion is located on the inner side of the first sleeve 7a. The second limiting portion is larger than the second through-hole in size. The second limiting portion is in contact with the first limiting portion, so as to limit the position of the first post portion and prevent the first post portion from detaching from the second through-hole. The first outer post 72 is configured to be electrically connected to a positive electrode of an electrical component.

The way of connecting the negative post 8 to the second end cap 1b may be the same as or different from the way of connecting the positive post 7 to the first end cap 1a. For example, a second sleeve 8a may be disposed between the negative post 8 and the second end cap 1b, or the second sleeve 8a may be omitted.

In the embodiments shown in FIG. 15 and FIG. 18, the second sleeve 8a is omitted between the negative post 8 and the second end cap 1b. The negative post 8 includes a second inner post 81 and a second outer post 82. The second outer post 82 is disposed on the outer side of the second end cap 1b. A first end of the second inner post 81 is located on the inner side of the second end cap 1b and connected to the second adapter piece 6. A second end of the second inner post 81 passes through the second end cap 1b and is connected to the second outer post 82.

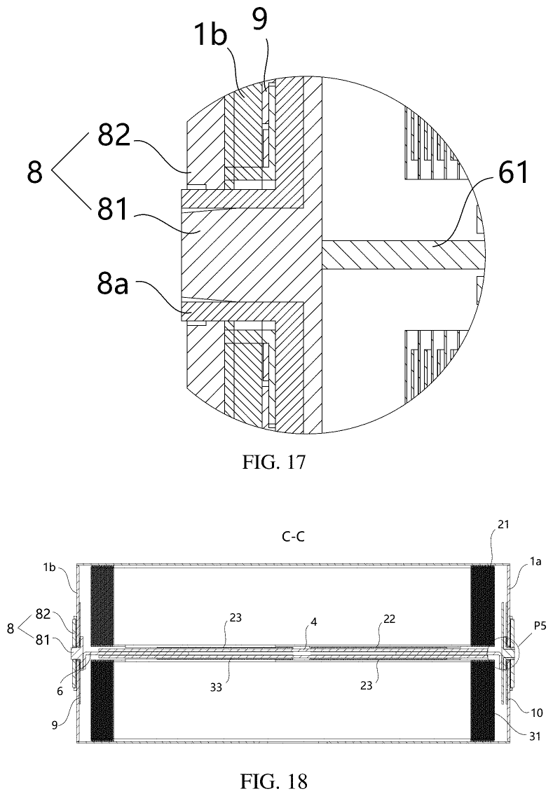

In the embodiments shown in FIG. 17 and FIG. 20, the second sleeve 8a is disposed between the negative post 8 and the second end cap 1b. The negative post 8 includes a second inner post 81 and a second outer post 82. The second sleeve 8a is mounted on the second end cap 1b. The second outer post 82 is disposed on an outer side of the second end cap 1b and connected to the second sleeve 8a. The second adapter piece 6 is connected to a second end of the second inner post 81. The second end of the second inner post 81 passes through the second sleeve 8a and is connected to the second sleeve 8a on an outer side of the housing 1. Compared with the inner side, the outer side of the housing 1 provides a larger operation space. Therefore, the second inner post 81 and the second sleeve 8a are fixed and connected on the outer side of the housing 1, thereby making the operation more convenient and helping to improve the assembling efficiency.

The negative post 8 containing the second inner post 81 and the second outer post 82 is disposed, the second sleeve 8a is disposed, and the second sleeve 8a is mounted on the second end cap 1b. During assembling of the battery cell, the second adapter piece 6 may be connected to the first end of the second inner post 81 first, and then the electrode assembly is put into the housing 1. Subsequently, during sealing of the second end cap 1b, the second end of the second inner post 81 is passed out of the housing 1 through the second sleeve 8a. After the second end cap 1b is fixed, the second inner post 81 is connected to the second sleeve 8a on the outer side of the housing 1. In this way, the second inner post 81 and the second outer post 82 are connected together through the second sleeve 8a to form the negative post 8.

The second sleeve 8a includes a second sleeve portion and a third limiting portion. A third through-hole is made on the second end cap 1b. The second sleeve portion is inserted into the third through-hole. The third limiting portion is connected to the second sleeve portion. The third limiting portion is located on the inner side of the second end cap 1b. The third limiting portion is larger than the third through-hole in size, so as to limit the position of the second sleeve portion and prevent the second sleeve portion from detaching from the third through-hole.

A fourth through-hole that runs through the second sleeve is made at the center of the second sleeve 8a. The second inner post 81 includes a first post portion and a fourth limiting portion. The first post portion is inserted into the fourth through-hole. The fourth limiting position is connected to the first post portion. The fourth limiting portion is located on the inner side of the second sleeve 8a. The fourth limiting portion is larger than the fourth through-hole in size. The fourth limiting portion is in contact with the third limiting portion, so as to limit the position of the first post portion and prevent the first post portion from detaching from the fourth through-hole. The second outer post 82 is configured to be electrically connected to a positive electrode of an electrical component.

In the embodiments shown in FIG. 15 and FIG. 18, a battery cell may be assembled according to the following steps: mounting the second inner post 81 and the second outer post 82 onto the second end cap 1b outside the housing 1 before the electrode assembly is put into the housing 1; connecting the second adapter piece 6 to the first negative tab 23 and the second negative tab 33, and then connecting the second adapter piece 6 to the second inner post 81, connecting the first adapter piece 5 to the first positive tab 22 and the second positive tab 32, and then connecting the first adapter piece 5 to the first inner post 71; subsequently, putting the whole of the second end cap 1b, the negative post 8, the second adapter piece 6, the electrode assembly, the first adapter piece 5, and the first inner post 71 into the housing 1; finally, sealing the first end cap 1a onto the second side face of the housing 1, where the first outer post 72 and the first sleeve 7a have been mounted onto the first end cap 1a, so that the second end of the first inner post 71 is passed out of the housing from the outer side of the housing 1. In this way, the first inner post 71 and the first sleeve 7a are connected by welding on the outer side of the housing 1 complete the assembling.

In the embodiments shown in FIG. 17 and FIG. 20, a second sleeve 8a is disposed between the negative post 8 and the second end cap 1b. Therefore, the assembling may be performed with reference to the assembling method of the first end cap 1a described above, and the assembling steps include: connecting the first inner post 71 to the first adapter piece 5, connecting the second inner post 81 to the second adapter piece 6, and then putting the electrode assembly into the housing 1, sealing the first end cap 1a, connecting the first inner post 71 to the second sleeve 7a, sealing the second end cap 1b, and then connecting the second inner post 81 and the second sleeve 8a.

A plurality of structures of the first adapter piece 5 and the second adapter piece 6 are available for selection.

For example, in the embodiments shown in FIG. 15 and FIG. 16, the first adapter piece 5 includes a first connecting portion 51 extending in a direction perpendicular to the first direction. The first connecting portion 51 is connected to the first positive tab 22 and the second positive tab 32. An end of the first connecting portion 51, which is close to the positive post 7, is connected to the positive post 7.

In the embodiments shown in FIG. 18 and FIG. 19, the first adapter piece 5 includes a first connecting portion 51 extending in a direction perpendicular to the first direction and a second connecting portion 52 extending in a direction parallel to the first direction. The first connecting portion 51 and the second connecting portion 52 are connected to form an L shape. The first connecting portion 51 is connected to the first positive tab 22 and the second positive tab 32. The second connecting portion 52 is connected to the positive post 7. This structure enhances stability of connection between the first adapter piece 5 and the positive post 7 by increasing the contact area between the second connecting portion 52 and the positive post 7.

Similarly, in the embodiments shown in FIG. 15 and FIG. 17, the second adapter piece 6 includes a third connecting portion 61 extending in a direction perpendicular to the first direction. The third connecting portion 61 is connected to the first negative tab 23 and the second negative tab 33. An end of the third connecting portion 61, which is close to the negative post 8, is connected to the negative post 8.

In the embodiments shown in FIG. 18 and FIG. 20, the second adapter piece 6 includes a third connecting portion 61 extending in a direction perpendicular to the first direction and a fourth connecting portion 62 extending in a direction parallel to the first direction. The third connecting portion 61 and the fourth connecting portion 62 are connected to form an L shape. The third connecting portion 61 is connected to the first negative tab 23 and the second negative tab 33, The fourth connecting portion 62 is connected to the negative post 8. This structure enhances stability of connection between the second adapter piece 6 and the negative post 8 by increasing the contact area between the fourth connecting portion 62 and the negative post 8.

In some embodiments, the battery cell 20 further includes a first insulation piece 9 disposed in the housing 1. The first insulation piece 9 is configured to electrically isolate the negative post 8 from the housing 1.

In some embodiments of this application, the first negative electrode plate 212 in the first electrode assembly 2 keeps insulated from the housing 1, and the second negative electrode plate 312 in the second electrode assembly 3 also keeps insulated from the housing 1. However, an end of the first positive electrode plate 211 in the first electrode assembly 2 is in direct contact with the first inner surface of the housing 1, and an end of the second positive electrode plate 311 in the second electrode assembly 3 is in direct contact with the second inner surface of the housing 1. In addition, the first positive tab 22 in the first electrode assembly 2 and the second positive tab 32 in the second electrode assembly 3 are both connected to the positive post 7 through the first adapter piece 5. Therefore, the first insulation piece 9 capable of electrically isolating the negative post 8 from the housing 1 can prevent the negative post 8 from being electrically connected to the positive post 7 through the housing 1 to result in a short circuit. The short circuit impairs the safety of the battery cell, and may lead to functional failure of the battery cell.

In the embodiment shown in FIG. 15 or FIG. 17, the battery cell 20 further includes a second insulation piece 10 disposed in the housing 1. The second insulation piece 10 is configured to electrically isolate the positive post 7 from the housing 1.

The second insulation piece 10 is omissible in other embodiments in view of the following factors: one end of the first positive electrode plate 211 in the first electrode assembly 2 is in direct contact with the first inner surface of the housing 1, one end of the second positive electrode plate 311 in the second electrode assembly 3 is in direct contact with the second inner surface of the housing 1, and the first positive tab 22 in the first electrode assembly 2 and the second positive tab 32 in the second electrode assembly 3 are both connected to the positive post 7 by the first adapter piece 5, that is, electrical connection is implemented between the positive post 7 and the housing 1 by the first adapter piece 5, the first positive tab 22, and the first positive electrode plate 211, and by the first adapter piece 5, the second positive tab 32, and the second positive electrode plate 311.

In some embodiments, the first body portion 21 further includes a first separator, the first body portion 21 is formed by winding the first positive electrode plate 211, the first negative electrode plate 212, and the first separator together, and the first direction is parallel to a winding centerline of the first body portion 21; and/or, the second body portion 31 further includes a second separator, the second body portion 31 is formed by winding the second positive electrode plate 311, the second negative electrode plate 312, and the second separator together, and the first direction is parallel to a winding centerline of the second body portion 31. In such embodiments, the first body portion 21 and the second body portion 31 are both jelly-roll structures. In the case of a jelly-roll structure, the first direction is the winding centerline of the first body portion 21 and the second body portion 31.

In other embodiments, the first body portion 21 and the second body portion 31 may be manufactured by stacking the positive electrode plate, the negative electrode plate, and the separator in sequence. In the case of the stacked structure, a direction in which the positive and negative electrode plates protrude from two ends may be used as the first direction.

In some embodiments of this application, the housing 1 is made of a metal material. Both the first positive electrode plate 211 and the second positive electrode plate 311 are made of a metal material. Therefore, metal-to-metal direct contact is implemented between the first positive electrode plate 211 and the housing 1, and between the second positive electrode plate 311 and the housing 1, thereby greatly improving the heat transfer efficiency and effectively reducing the temperature of the battery cell.

This application further provides a battery, including the battery cell.

This application further provides an electrical device, including the battery. The battery is configured to supply electrical energy to the electrical device.

This application further provides a method for manufacturing a battery cell, including:

providing a housing 1, a first body portion 21, and a second body portion 31, where the first body portion 21 includes a. first positive electrode plate 211 and a first negative electrode plate 212, and the second body portion 31 includes a second positive electrode plate 311 and a second negative electrode plate 312;

disposing both the first body portion 21 and the second body portion 31 in the housing 1; and

spacing out the first body portion 21 and the second body portion 31 along a first direction, where an end of the first positive electrode plate 211, which is oriented away from the second body portion 31 along the first direction, contacts a first inner surface of the housing 1, and an end of the first negative electrode plate 212, which is oriented away from the second body portion 31 along the first direction, is insulated from the first inner surface of the housing 1; and/or, an end of the second positive electrode plate 311, which is oriented away from the first body portion 21 along the first direction, contacts a second inner surface of the housing 1, an end of the second negative electrode plate 312, which is oriented away from the first body portion 21 along the first direction, is insulated from the second inner surface of the housing 1, and the first inner surface is disposed opposite to the second inner surface.

This application further provides an apparatus for manufacturing a. battery cell, including a providing apparatus and a placement apparatus. The providing apparatus is configured to provide a housing 1, a first body portion 21, and a second body portion 31. The first body portion 21 includes a first positive electrode plate 211 and a first negative electrode plate 212. The second body portion 31 includes a second positive electrode plate 311 and a second negative electrode plate 312. The placement apparatus is configured to dispose both the first body portion 21 and the second body portion 31 in the housing 1, and space out the first body portion 21 and the second body portion 31 along a first direction, where an end of the first positive electrode plate 211, which is oriented away from the second body portion 31 along the first direction, contacts a first inner surface of the housing 1, and an end of the first negative electrode plate 212, which is oriented away from the second body portion 31 along the first direction, is insulated from the first inner surface of the housing 1 and/or, an end of the second positive electrode plate 311, which is oriented away from the first body portion 21 along the first direction, contacts a second inner surface of the housing 1, an end of the second negative electrode plate 312, which is oriented away from the first body portion 21 along the first direction, is insulated from the second inner surface of the housing 1, and the first inner surface is disposed opposite to the second inner surface.

The beneficial effects of each embodiment of the battery cell disclosed in this application are also applicable to the battery, the electrical device, the method for manufacturing a battery cell, and the apparatus for manufacturing a battery cell, and are not repeated here.

The following describes the structures of battery cells according to some embodiments of this application with reference to FIG. 3 to FIG. 17.

Refer to FIG. 3 to FIG. 6, which are a three-dimensional view, front view, top view, and left view, respectively, of a battery cell 20. The battery cell 20 includes a housing 1, The housing 1 includes an accommodation body, a first end cap, and a second end cap. A first opening is made at a left side of the accommodation body, and a second opening is made at a right side. The first end cap is configured to close the first opening, and the second end cap is configured to close the second opening. A negative post 8 is mounted on the first end cap, and a positive post 7 is mounted on the second end cap.

As shown in FIG. 7, a first electrode assembly 2 and a second electrode assembly 3 are disposed inside the housing 1. A first direction is a vertical direction, and the first electrode assembly 2 is disposed above the second electrode assembly 3. The first electrode assembly 2 and the second electrode assembly 3 are identical in structure, and are symmetric to each other vertically with respect to a midline between the first electrode assembly 2 and the second electrode assembly 3.

The first electrode assembly 2 includes a first body portion 21, and a first positive tab 22 and a first negative tab 23 that extend downward from the first body portion 21. The second electrode assembly 3 includes a second body portion 31, and a second positive tab 32 and a second negative tab 33 that extend upward from the second body portion 31. The first positive tab 22 and the second positive tab 32 are oppositely disposed at a side that is of the housing 1 and that is close to the second end cap. The first negative tab 23 and the second negative tab 33 are oppositely, disposed at a side that is of the housing 1 and that is close to the first end cap.

In the embodiment shown in FIG. 7, the first positive tab 22 and the second positive tab 32 are connected to the first adapter piece 5 separately. The first adapter piece 5 is connected to the positive post 7. The first negative tab 23 and the second negative tab 33 are connected to the second adapter piece 6 separately. The second adapter piece 6 is connected to the negative post 8.

The first positive tab 22, the first negative tab 23, the second positive tab 32, and the second negative tab 33 are all disposed between the first body portion 21 and the second body portion 31. The positive post 7 and the negative post 8 are disposed on the right side and the left side of the housing 1 respectively. Therefore, the first adapter piece 5 can be extended to the positive post 7 basically horizontally, and the second adapter piece 6 can be extended to the negative post 8 basically horizontally, thereby effectively shortening the first adapter piece 5 and the second adapter piece 6, reducing heat emission, and lowering the temperature of the battery cell 20.

A first insulation piece 9 and a second insulation piece 10 are further disposed on the inner side of the housing 1. The first insulation piece 9 is configured to electrically isolate the negative post 8 from the housing 1, and the second insulation piece 10 is configured to electrically isolate the positive post 7 from the housing 1. In some embodiments, the second insulation piece 10 is omissible. The first insulation piece 9 and the second insulation piece 10 may be made of a plastic material. The positive post 7 may be connected to the housing 1, and the negative post 8 may be connected to the housing 1, by riveting. A sealing ring may be disposed at the junction. The sealing ring may be made of a fluororubber material.

As shown in FIG. 8, the first body portion 21 includes a first positive electrode plate 211 and a first negative electrode plate 212. The first positive electrode plate 211 includes a first current collector 211a and a first active material layer 211b. On the top of the first body portion 21, the first current collector 211a. is longer than the first active material layer 211b. The first current collector 211a is in close contact with a top inner surface of the housing 1, thereby enhancing the effect of heat transfer between the first positive electrode plate 211 and the housing 1, enabling the heat to be dissipated out of the housing 1 in time, and effectively lowering the temperature of the battery cell 20. Both the second active material layer 211b and the first negative electrode plate 212 are at a preset distance from the top inner surface of the housing 1. Moreover, the first negative electrode plate 212 is longer than the first active material layer 211b.

As shown in FIG. 9, the second body portion 31 includes a second positive electrode plate 311 and a second negative electrode plate 312. The second positive electrode plate 311 includes a second current collector 311a and a second active material layer 311b. At the bottom of the second body portion 31, the second current collector 311a is longer than the second active material layer 311h. The second current collector 311a is in close contact with a bottom inner surface of the housing 1, thereby enhancing the effect of heat transfer between the second positive electrode plate 311 and the housing 1, enabling the heat to be dissipated out of the housing 1 in time, and effectively lowering the temperature of the battery cell 20. Both the second active material layer 311b and the second negative electrode plate 312 are at a preset distance from the bottom inner surface of the housing 1. Moreover, the second negative electrode plate 312 is longer than the second active material layer 311b.

As shown in FIG. 10 and FIG. 11, the first positive tab 22 and the first negative tab 23 extend from the first body portion 21 separately and are bent to form a U-shaped structure with an opening. The second positive tab 32 and the second negative tab 33 extend from the second body portion 31 separately and are bent to form a U-shaped structure with an opening.

The first negative electrode plate 212 includes a third current collector 212a and a third active material layer 212b. At a position close to the negative post 8 at the bottom of the first body portion 21, the third current collector 212a is longer than the third active material layer 212b, and the third current collector 212a is in contact with the first negative tab 23. Both the third active material layer 212b and the first positive electrode plate 211 are at a preset distance from the first negative tab 23. Moreover, the first positive electrode plate 211 is longer than the third active material layer 212b.

The second negative electrode plate 312 includes a fourth current collector 312a and a fourth active material layer 312b. At a position close to the negative post 8 on the top of the second body portion 31, the fourth current collector 312a is longer than the fourth active material layer 312b, and the fourth current collector 312a is in contact with the second negative tab 33. Both the fourth active material layer 312b and the second positive electrode plate 311 are at a preset distance from the second negative tab 33. Moreover, the second positive electrode plate 311 is longer than the fourth active material layer 312b.

In some embodiments, at a position close to the positive post 7 at the bottom of the first body portion 21, the first current collector 211a is longer than the first active material layer 211b, and the first current collector 211a is in contact with the first positive tab 22. Both the first active material layer 211b and the first negative electrode plate 212 are at a preset distance from the first positive tab 22. Moreover, the first negative electrode plate 212 is longer than the first active material layer 211b. At a position close to the positive post 7 at the bottom of the second body portion 31, the second current collector 311a is longer than the second active material layer 311b, and the second current collector 311a is in contact with the second positive tab 32. Both the second active material layer 311b and the second negative electrode plate 312 are at a preset distance from the second positive tab 32. Moreover, the second negative electrode plate 312 is longer than the second active material layer 311b.

As shown in FIG. 12 to FIG. 14, a bracket 4 is disposed between the first body portion 21 and the second body portion 31. The bracket 4 is in a U-shaped structure. The bracket 4 includes a first support portion 41, a second support portion 42, and a third support portion 43 connected between the first support portion 41 and the second support portion 42. The first support portion 41 and the second support portion 42 are in a plate structure. The first support portion 41 is inserted into openings formed on the first positive tab 22 and the first negative tab 23 separately. The second support portion 42 is inserted into openings formed on the second positive tab 32 and the second negative tab 33 separately.

In the embodiments shown in FIG. 15, FIG. 16, FIG. 18, and FIG. 19, the battery cell includes a first end cap 1a. and a second end cap 1b. A first opening is made on the first side face of the housing 1, and a second opening is made on the second side face of the housing 2. The first end cap 1a. is configured to seal the first opening, and the second end cap 1b is configured to seal the second opening. The positive post 7 is mounted on the first end cap 1a, and the negative post 8 is mounted on the second end cap 1b. The positive post 7 includes a first inner post 71 and a first outer post 72. The first sleeve 7a is mounted on the first end cap 1a. The first outer post 72 is disposed on an outer side of the first end cap 1a and connected to the first sleeve 7a. The first adapter piece 5 is connected to a first end of the first inner post 71. A second end of the first inner post 71 passes through the first sleeve 7a and is connected to the first sleeve 7a on an outer side of the housing 1. The negative post 8 includes a second inner post 81 and a second outer post 82. The second outer post 82 is disposed on the outer side of the second end cap 1b. A first end of the second inner post 81 is located on the inner side of the second end cap 1b and connected to the second adapter piece 6. A second end of the second inner post 81 passes through the second end cap 1b and is connected to the second outer post 82.

In the embodiments shown in FIG. 17 and FIG. 20, the negative post 8 includes a second inner post 81 and a second outer post 82. The second sleeve 8a is mounted on the second end cap 1b. The second outer post 82 is disposed on an outer side of the second end cap 1b and connected to the second sleeve 8a. The second adapter piece 6 is connected to a second end of the second inner post 81. The second end of the second inner post 81 passes through the second sleeve 8a and is connected to the second sleeve 8a on an outer side of the housing 1.

As shown in FIG. 15 to FIG. 17, in this embodiment, both the first adapter piece 5 and the second adapter piece 6 are flat and straight in shape. One end of the first adapter piece 5 is connected to the first positive tab 22 and the second positive tab 32, and the other end is connected to the positive post 7. One end of the second adapter piece 6 is connected to the first negative tab 23 and the second negative tab 33, and the other end is connected to the negative post 8.

As shown in FIG. 18 to FIG. 20, in this embodiment, both the first adapter piece 5 and the second adapter piece 6 are L-shaped. The first connecting portion 51 of the first adapter piece 5 is connected to the first positive tab 22 and the second positive tab 32. The second connecting portion 52 is connected to the positive post 7, The stability of electrical connection between the second connecting portion 52 and the positive post 7 can be enhanced by increasing the contact area between the second connecting portion 52 and the positive post 7. The third connecting portion 61 of the second adapter piece 6 is connected to the first negative tab 23 and the second negative tab 33. The fourth connecting portion 62 is connected to the negative post 8. The stability of electrical connection between the fourth connecting portion and the negative post 8 can be enhanced by increasing the contact area between the fourth connecting portion 62 and the negative post 8.

Although this application has been described with reference to illustrative embodiments, various improvements may be made to the embodiments without departing from the scope of this application, and the components in this application may be replaced with equivalents. Particularly, to the extent that no structural conflict exists, various technical features mentioned in different embodiments may be combined in any manner. This application is not limited to the specific embodiments disclosed herein, but includes all technical solutions falling within the scope of the claims.

What is claimed is:

1. A battery cell, comprising:
a housing;
a first body structure, disposed in the housing, wherein the first body structure comprises a first positive electrode plate and a first negative electrode plate; and
a second body structure, disposed in the housing, wherein the second body structure comprises a second positive electrode plate and a second negative electrode plate, wherein
the first body structure and the second body structure are spaced out along a first direction, an end of the first positive electrode plate, which is oriented away from the second body structure along the first direction, protrudes beyond the first body structure and contacts a first inner surface of the housing, and the first negative electrode plate is insulated from the first inner surface of the housing; and/or, an end of the second positive electrode plate, which is oriented away from the first body structure along the first direction, protrudes beyond the second body structure and contacts a second inner surface of the housing, the second negative electrode plate is insulated from the second inner surface of the housing, and the first inner surface is disposed opposite to the second inner surface.

2. The battery cell according to claim 1, wherein the first positive electrode plate comprises a first current collector and a first active material layer formed on the first current collector, and an end of the first current collector, which is oriented away from the second body structure along the first direction, protrudes beyond the first active material layer and contacts the first inner surface of the housing; the second positive electrode plate comprises a second current collector and a second active material layer formed on the second current collector, and an end of the second current collector, which is oriented away from the first body structure along the first direction, protrudes beyond the second active material layer and contacts the second inner surface of the housing.

3. The battery cell according to claim 1, wherein an end of the first negative electrode plate, which is oriented away from the second body structure along the first direction, is at a first preset distance from the first inner surface of the housing, and an end of the second negative electrode plate, which is oriented away from the first body structure along the first direction, is at a second preset distance from the second inner surface of the housing.

4. The battery cell according to claim 1, further comprising a first positive tab and a first negative tab that extend from the first body structure as well as a second positive tab and a second negative tab that extend from the second body structure, wherein the first positive tab and the first negative tab are disposed at an end of the first body structure, the end of the first body structure is close to the second body structure along the first direction, the second positive tab and the second negative tab are disposed at an end of the second body structure, and the end of the second body structure is close to the first body structure along the first direction.

5. The battery cell according to claim 1, further comprising a bracket, wherein the bracket is disposed between the first body structure and the second body structure to make the first positive electrode plate keep in contact with the first inner surface of the housing, and to make the second positive electrode plate keep in contact with the second inner surface of the housing.

6. The battery cell according to claim 5, wherein the bracket comprises a first support structure, a second support structure, and a third support structure connected between the first support structure and the second support structure, the first support structure serves as a support between the first body structure and a first positive tab and a support between the first body structure and a first negative tab, and the second support structure serves as a support between the second body structure and a second positive tab and a support between the second body structure and a second negative tab.

7. The battery cell according to claim 4, further comprising a first adapter, a second adapter, a positive post, and a negative post, wherein the first positive tab and the second positive tab are both connected to the first adapter, the first adapter is connected to the positive post, the first negative tab and the second negative tab are both connected to the second adapter, and the second adapter is connected to the negative post.

8. The battery cell according to claim 7, wherein the positive post is mounted on a first side face of the housing, the negative post is mounted on a second side face of the housing, the first side face is disposed opposite to the second side face, and both the first side face and the second side face are parallel to the first direction.

9. The battery cell according to claim 8, further comprising a first end cap and a second end cap, wherein a first opening is disposed on the first side face of the housing, a second opening is disposed on the second side face of the housing, the first end cap seals the first opening, and the second end cap seals the second opening.

10. The battery cell according to claim 9, further comprising a first sleeve, wherein the positive post comprises a first inner post and a first outer post, the first sleeve is mounted on the first end cap, the first outer post is disposed on an outer side of the first end cap and connected to the first sleeve, the first adapter is connected to a first end of the first inner post, and a second end of the first inner post passes through the first sleeve and is connected to the first sleeve on an outer side of the housing.

11. The battery cell according to claim 9, further comprising a second sleeve, wherein the negative post comprises a second inner post and a second outer post, the second sleeve is mounted on the second end cap, the second outer post is disposed on an outer side of the second end cap and connected to the second sleeve, the second adapter is connected to a second end of the second inner post, and the second end of the second inner post passes through the second sleeve and is connected to the second sleeve on an outer side of the housing.

12. The battery cell according to claim 7, wherein the first adapter comprises a first connecting structure extending in a direction perpendicular to the first direction, the first connecting structure is connected to the first positive tab and the second positive tab, an end that is of the first connecting structure and that is close to the positive post is connected to the positive post; or, the first adapter comprises the first connecting structure extending in the direction perpendicular to the first direction and a second connecting structure extending in a direction parallel to the first direction, the first connecting structure and the second connecting structure are connected to form an L shape, the first connecting structure is connected to the first positive tab and the second positive tab, and the second connecting structure is connected to the positive post.

13. The battery cell according to claim 7, wherein the second adapter comprises a third connecting structure extending in a direction perpendicular to the first direction, the third connecting structure is connected to the first negative tab and the second negative tab, an end that is of the third connecting structure and that is close to the negative post is connected to the negative post; or, the second adapter comprises the third connecting structure extending in the direction perpendicular to the first direction and a fourth connecting structure extending in a direction parallel to the first direction, the third connecting structure and the fourth connecting structure are connected to form an L shape, the third connecting structure is connected to the first negative tab and the second negative tab, and the fourth connecting structure is connected to the negative post.

14. The battery cell according to claim 7, further comprising a first insulator disposed in the housing, wherein the first insulator electrically isolates the negative post from the housing.

15. The battery cell according to claim 1, wherein the first body structure further comprises a first separator, the first body structure is formed by winding the first positive electrode plate, the first negative electrode plate, and the first separator together, and the first direction is parallel to a winding centerline of the first body structure; and/or, the second body structure further comprises a second separator, the second body structure is formed by winding the second positive electrode plate, the second negative electrode plate, and the second separator together, and the first direction is parallel to a winding centerline of the second body structure.

16. The battery cell according to claim 1, wherein the housing is made of a metal material.

17. A battery, comprising the battery cell according to claim 1.

18. An electrical device, comprising the battery according to claim 17, wherein the battery is configured to supply electrical energy to the electrical device.

19. A method for manufacturing a battery cell, comprising:
providing a housing, a first body structure, and a second body structure, wherein the first body structure comprises a first positive electrode plate and a first negative electrode plate, and the second body structure comprises a second positive electrode plate and a second negative electrode plate;
disposing both the first body structure and the second body structure in the housing; and
spacing out the first body structure and the second body structure along a first direction, wherein an end of the first positive electrode plate, which is oriented away from the second body structure along the first direction, contacts a first inner surface of the housing, and an end of the first negative electrode plate, which is oriented away from the second body structure along the first direction, is insulated from the first inner surface of the housing; and/or, an end of the second positive electrode plate, which is oriented away from the first body structure along the first direction, contacts a second inner surface of the housing, an end of the second negative electrode plate, which is oriented away from the first body structure along the first direction, is insulated from the second inner surface of the housing, and the first inner surface is disposed opposite to the second inner surface.
